(19) United States
(12) Patent Application Publication
(10) Pub. No.: US 2024/0418064 A1
(43) Pub. Date: Dec. 19, 2024

(54) Stator Winding Insulation Techniques for ESP Motors

(71) Applicant: Halliburton Energy Services, Inc., Houston, TX (US)

(72) Inventors: Michael Rimmer, Frimley (GB); Hassan Mansir, Frimley (GB)

(21) Appl. No.: 18/209,021

(22) Filed: Jun. 13, 2023

(51) Int. Cl. E21B 43/12; H02K 3/30; H02K 3/34

(52) U.S. Cl. CPC E21B 43/128; H02K 3/30; H02K 3/34

(57) ABSTRACT

Stators in downhole ESP motors often are used in the sorts of high temperature operations in which rigid, inorganic insulation may prove useful. However, such rigid insulation materials may have inherent manufacturability issues which can limit usage, for example in elongated motors of the sort often used with downhole electrical submersible pumps. Disclosed embodiments provide solutions for effectively insulating conductor portions in the slots of a stator lamination in an ESP motor, and for effectively manufacturing, managing inventory for, and assembling improved stators.

### FIELD

This disclosure relates generally to the field of pumping. More particularly, this disclosure relates to the field of electric submersible pumps for use downhole in a well. Still more particularly, this disclosure relates to downhole motors of the sort which may be used in electric submersible pumps, and to stator winding insulation improvements for such downhole motors.

### BACKGROUND

Electric submersible pump (ESP) assemblies are used to artificially lift fluid to the surface, for example in deep wells such as oil or water wells. ESP assemblies are commonly used in the oil and gas industry to extract fluids from underground reservoirs. By way of example, the artificial lift provided by ESP assemblies may be useful in situations when the reservoir does not have sufficient energy to allow the well to naturally produce effectively, or when an additional boost to production of the well is desired. Improvements to ESP assemblies can improve overall production of fluids from a well, which may thereby improve the profitability of the well. Improvements in the construction and assembly of the ESP and/or its component parts may result in lower ESP costs and/or in improved characteristics (such as durability or life).

A typical ESP assembly comprises, from bottom to top, an electric motor, a seal unit, a pump intake, and a pump (e.g. typically a centrifugal pump), which are all mechanically connected together with shafts and shaft couplings. The electric motor supplies torque to the shafts, which provides power to the centrifugal pump. The electric motor is isolated from a wellbore environment by a housing and by the seal unit. The seal unit can act as an oil reservoir for the electric motor. The oil can function both as a dielectric fluid and as a lubricant in the electric motor. The seal unit also may provide pressure equalization between the electric motor and the wellbore environment.

The centrifugal pump is configured to transform mechanical torque received from the electric motor via a drive shaft to fluid pressure which can lift fluid up the wellbore. For example, the centrifugal pump typically has rotatable impellers within stationary diffusers. A shaft extending through the centrifugal pump is operatively coupled to the motor, and the impellers of the centrifugal pump are rotationally coupled to the shaft. In use, the motor can rotate the shaft, which in turn can rotate the impellers of the centrifugal pump relative to and within the stationary diffusers, thereby imparting pressure to the fluid within the centrifugal pump. The electric motor is generally connected to a power source located at the surface of the well using a cable and a motor lead extension. The ESP assembly is placed into the well and usually is inside a well casing. In a cased completion, the well casing separates the ESP assembly from the surrounding formation. In operation, perforations in the well casing allow well fluid to enter the well casing and flow to the pump intake for transport to the surface.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a schematic illustration of an exemplary electric submersible pump (ESP) assembly disposed in a wellbore, according to an embodiment of the disclosure;

FIG. 2 is a cross-sectional view of an exemplary motor for the electric submersible pump assembly of FIG. 1, according to an embodiment;

FIG. 3 is an exploded isometric view of the motor of FIG. 2, according to an embodiment of the disclosure;

FIG. 4 is a partial cut-away isometric view of an exemplary ESP motor having a plurality of rotor modules with rotor bearing assemblies therebetween, according to an embodiment of the disclosure;

FIG. 5 is a schematic diagram of an exemplary winding embodiment within an exemplary stator lamination stack of an exemplary ESP motor, according to an embodiment;

FIG. 6 is a schematic diagram of another exemplary winding embodiment within another exemplary stator lamination stack, according to an embodiment;

FIG. 7 is a schematic diagram illustrating conceptually staggering of the insulation breaks (e.g. to prevent turn-to-turn shorts), with the staggers also surrounded by overlapping insulation to prevent ground fault issues, according to an embodiment;

FIG. 8A illustrates a partial axial cross-sectional view of a slot within an exemplary stator, according to an embodiment;

FIG. 8B illustrates a slot cross-sectional view of FIG. 8A showing the overlapping insulation fitting within the spacer, according to an embodiment;

FIG. 8C illustrates a slot cross-sectional view of FIG. 8A at a location without overlapping insulation (e.g. in the lamination stack), according to an embodiment;

FIG. 9 illustrates a partial axial cross-sectional view of an alternate embodiment of a slot in an exemplary stator, according to an embodiment;

FIG. 10 illustrates an axial cross-sectional view of a slot in an exemplary stator, according to an embodiment;

FIG. 11 illustrates an axial cross-sectional view of another exemplary embodiment of a slot in an exemplary stator, according to an embodiment;

FIG. 12 illustrates an axial cross-sectional view of yet another exemplary embodiment of a slot in an exemplary stator, according to an embodiment;

FIG. 13 illustrates schematically an alternate exemplary embodiment for applying overlapping insulation, according to an embodiment; and

FIG. 14 illustrates schematically another alternate exemplary embodiment for insulating breaks in the insulator, according to an embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As used herein, orientation terms “upstream,” “downstream,” “up,” and “down” are defined relative to the direction of flow of well fluid in the well casing. “Upstream” is directed counter to the direction of flow of well fluid, towards the source of well fluid (e.g., towards perforations in well casing through which hydrocarbons flow out of a subterranean formation and into the casing). “Downstream” is directed in the direction of flow of well fluid, away from the source of well fluid. “Down” is directed counter to the direction of flow of well fluid, towards the source of well fluid. “Up” is directed in the direction of flow of well fluid, away from the source of well fluid.

Disclosed embodiments may relate to improved stator winding insulating techniques, for example for ESP motors. High temperature motors, for example operating above 280° C., typically may require inorganic insulation materials, and in particular rigid insulation such as ceramic, to form the winding insulation of the stator. In typical electrical submersible motor exemplary embodiments for downhole use, such as in a well, the stator can be of significant length. For example, the stator can be longer, and typically significantly longer, than the available manufacturable lengths of the rigid insulation. Thus, embodiments may use several lengths of rigid insulation to jointly span the length of the stator. This can lead to several difficulties in manufacturing the stator. For example, to maintain the effective insulation of the winding, any gaps formed by using several such lengths of rigid insulation may need to be addressed.

Also, to utilize rigid insulation effectively in an ESP motor, a precision winding can be created, for example as disclosed in more detail in U.S. Pat. Nos. 10,199,897 and 10,523,077, both of which are incorporated herein by reference in full to the extent not inconsistent and/or incompatible with the specific disclosure herein. Typically, for an exemplary coil from one phase within the motor (e.g. a 3-phase motor) the winding may have many different lengths of insulation extending from the end of the lamination stack. These extending ends typically can have small step sizes in length, potentially magnitudes less than the length of the insulator. As a result, a multitude of different lengths of insulators could be used to insulate the winding, leading to manufacturing, inventory, and assembling difficulties associated therewith. Further, this issue can be magnified greatly by the use of several lengths of rigid insulation to span the length of the stator. This disclosure addresses systems and methods to limit such insulation length variants, while effectively maintaining the insulation of the stator winding, for example using rigid insulation in high temperature settings.

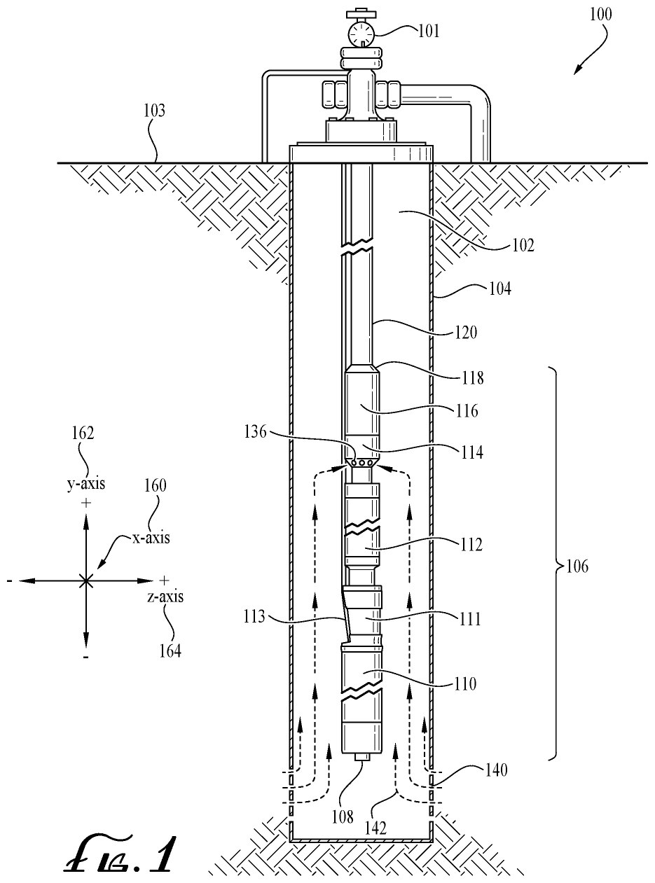

Turning now to FIG. 1, an exemplary producing well environment 100 is described. In an embodiment, the environment 100 comprises a wellhead 101 above a wellbore 102 located at the surface 103. A casing 104 is provided within the wellbore 102. For convenience of reference, FIG. 1 provides a directional reference comprising three coordinate axes—an X-axis 160 where positive displacements along the X-axis 160 are directed into the sheet and negative displacements along the X-axis 160 are directed out of the sheet; a Y-axis 162 where positive displacements along the Y-axis 162 are directed upwards on the sheet and negative displacements along the Y-axis 162 are directed downwards on the sheet; and a Z-axis 164 where positive displacements along the Z-axis 164 are directed rightwards on the sheet and negative displacements along the Z-axis 164 are directed leftwards on the sheet. In the embodiment of FIG. 1, the Y-axis 162 is approximately parallel to a central axis of a vertical portion of the wellbore 102.

An exemplary electric submersible pump (ESP) assembly 106 is deployed downhole in a well within the casing 104 and comprises an optional sensor unit 108, an electric motor 110 with a motor head 111, a seal unit 112, an electric power cable 113, a pump intake 114, a centrifugal pump 116, and a pump outlet 118 that couples the centrifugal pump 116 to a production tubing 120. The centrifugal pump 116 is operatively coupled to the motor 110 by a shaft (not shown). In an embodiment, the ESP assembly 106 may employ thrust bearings in several places, for example in the electric motor 110, in the seal unit 112, and/or in the centrifugal pump 116. While not shown in FIG. 1, in an embodiment, the ESP assembly 106 can comprise a gas separator that may employ one or more thrust bearings. The motor head 111 couples the electric motor 110 to the seal unit 112. The electric power cable 113 may connect to a source of electric power at the surface 103 and to the electric motor 110, for example being configured to provide power from the source of electric power at the surface 103 to the electric motor 110.

In operation, the casing 104 is pierced by perforations 140, and reservoir fluid 142 flows through the perforations 140 into the wellbore 102. The fluid 142 flows downstream in an annulus formed between the casing 104 and the ESP assembly 106, is drawn into the pump intake 114, is pumped by the centrifugal pump 116, and is lifted through the production tubing 120 to the wellhead 101 to be produced at the surface 103. The fluid 142 may comprise hydrocarbons such as oil and/or gas, water, or both hydrocarbons and water.

While the example illustrated in FIG. 1 relates to land-based subterranean wells, similar ESP systems can be used in a subsea environment and/or may be used in subterranean environments located on offshore platforms, drill ships, semi-submersibles, drilling barges, etc. And while the wellbore is shown in FIG. 1 as being approximately vertical, in other embodiments, the wellbore may be horizontal, deviated, or any other type of well. Also, while the pump of the ESP is described with respect to FIG. 1 as a centrifugal pump, other types of pumps (such as a rod pump, a progressive cavity pump, any other type of pump suitable for the system, or combinations thereof) may be used instead.

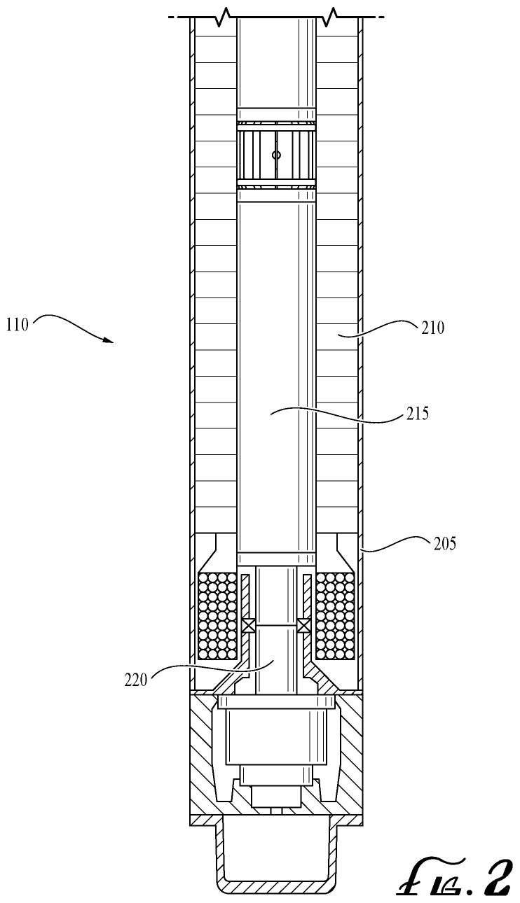

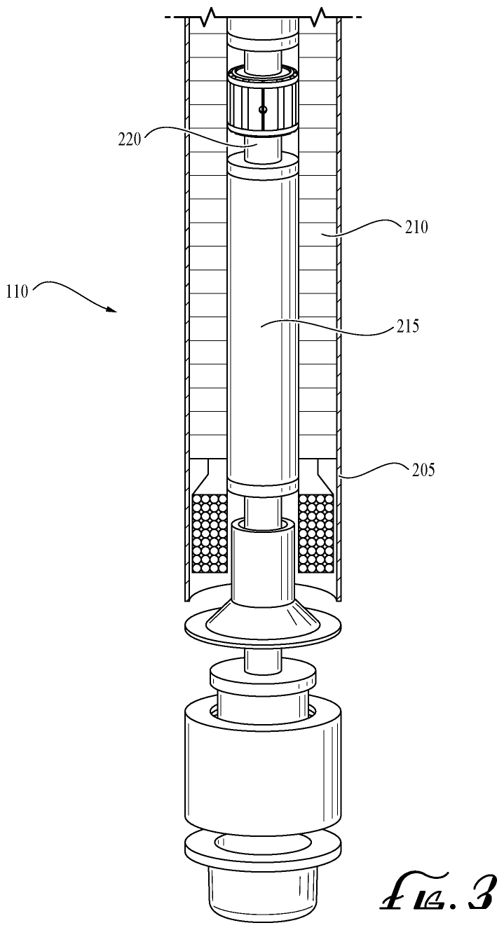

As shown in FIGS. 2-3, an exemplary motor 110 of the ESP assembly includes a housing 205, a stator 210, a rotor 215, and a drive shaft 220. The housing 205 typically comprises a hollow cylinder or tube and is configured to protect the internal components of the motor 110 from the external environment. The stator 210 also typically comprises a hollow cylinder and is secured to the housing 205 (e.g. to the inner surface of the housing 205) so as to be stationary within the housing 205. Typically, the stator 210 comprises a plurality of laminations (which may comprise spacer and/or end laminations in some embodiments), which may be thin sheets of steel, silicon steel, iron, nickel alloy, cobalt alloy, any compatible non-magnetic metal (e.g. bronze, stainless steel), polymer or inorganic material (e.g. ceramic), wrapped by a plurality of electrically conductive windings. When energized, the windings generate a rotating magnetic field for interaction with the rotor 215 to induce rotation of the rotor 215. The rotor 215 also typically comprises a hollow cylinder and is concentrically arranged between the stator 210 and the drive shaft 220, for example with the drive shaft 220 typically extending longitudinally along the centerline of the motor 110, the rotor 215 disposed around the drive shaft 220, and the stator 210 disposed around the rotor 215, within the housing 205. The rotor 215 is rotatable within the stator 210 and secured to the drive shaft 220, such that rotation of the rotor 215 drives the drive shaft 220. In embodiments, the motor 110 may be a two or more pole motor, a three-phase squirrel cage induction motor, a permanent magnet motor (PMM), a hybrid PMM, or other motor configuration.

Depending on the power requirements of the motor 110, the rotor 215 typically may include a number of rotor modules, which together jointly form the rotor 215, with each rotor module secured to the drive shaft 220. The rotational magnetic field of the stator 210 when energized can induce rotation of the rotor 215, and thereby the drive shaft 220, with the drive shaft 220 transmitting rotational torque from the motor 110 to the pump 116. As shown in FIG. 4, the rotor modules 405 (jointly forming the rotor 215) are spaced apart from each other along the drive shaft 220, with a rotor bearing assembly 410 typically located between adjacent rotor modules 405. Rotor bearing assemblies 410 can also be located at the top of the uppermost rotor module 405 and/or the bottom of the lowermost rotor module 405 (e.g. at the top and bottom of the rotor). In some embodiments, the rotor bearing assembly 410 can be a hydrodynamic bearing assembly. Similarly, the stator 210 can in some embodiments be formed of a plurality of modules (as discussed herein below), which can be axially disposed within the housing 205.

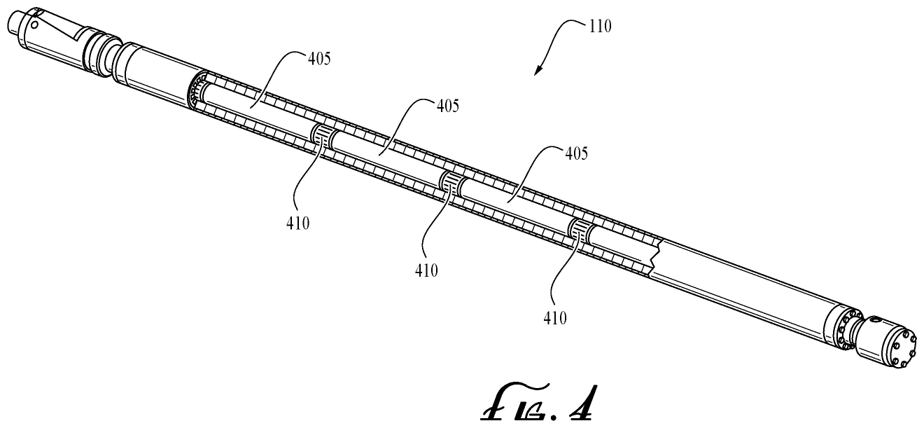

A simplified schematic of an exemplary precision winding of a downhole motor stator 210 is shown in FIG. 5. In this example the conductor 505 forms a coil with 3 turns. Each turn is spaced by a distance S. Each turn has an electrical insulator 520 which is shorter than the portion of winding/conductor 505 that it covers, but sufficient to insulate the winding/conductor 505 to ground and to adjacent phases (e.g. to adjacent conductor 505 portions). These insulators 520, and the conductors 505 they contain, pass through slots 535 in the lamination stack 530 of the stator 210. The end lengths of the insulators 520 are staggered, and in this case, they are also staggered by a distance S (e.g. corresponding to the turn spacing). In the example shown for a 3-turn design, this results in 6 different insulator 520 lengths (e.g. L1, L2, L3, L4, L5, and L6). For a higher number of turns the number of different lengths of the insulators 520 would further increase.

For a typical ESP motor 110, the length of the motor 110 can be high, for example approximately 3 to 20 meters, resulting in comparable conductor 505 portion lengths along the motor 110. For example, the length (e.g. approximately one of L1-L6) of the portion of the conductor 505 for each turn within one of the plurality of slots 535 may be comparable to the overall length of the motor 110. Rigid insulation such as ceramic can typically be manufactured with a length of up to 1 meter (e.g. approximately 0.3-1 meter). In some embodiments, perhaps higher lengths of rigid insulation, such as up to 3 meters, may be achievable. In the case of ceramic, these are typically extruded, then fired to form a rigid component (such as a tube), then finish machined if necessary. Thus, in practice, it may not be possible to provide the electrical insulators 520 as shown in the schematic illustration of FIG. 5, for example with a single unified length of rigid insulation spanning the length of the corresponding conductor 505 portion within the slot 535 (e.g. spanning approximately the length of the motor 110). In embodiments, multiple insulating sections 610 may be needed to cover the total length of the corresponding conductor 505 portion in one of the slots 535 in the lamination stack 530.

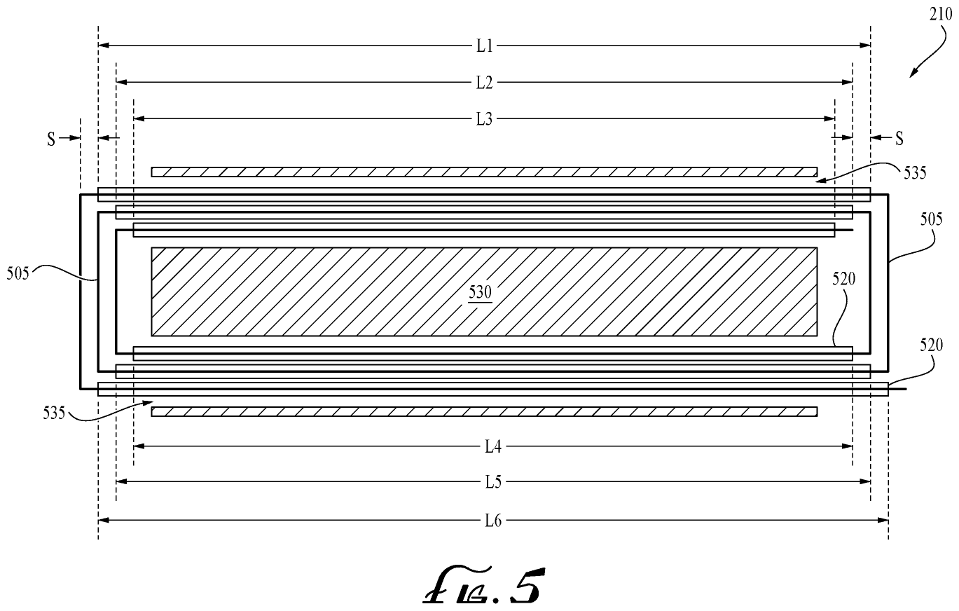

FIG. 6 is a schematic figure showing this approach conceptually as applied to the basic exemplary layout of FIG. 5, with an exemplary insulator 520 for each portion of the corresponding conductor 505 divided, for example being formed of a plurality of abutting insulating sections 610 (which each may be rigid and/or tubular). In this example, two divisions are shown over the length of the insulator 520 (e.g. the insulator 520 comprises two abutting insulating sections 610), but this is merely exemplary. Thus, in other embodiments, each insulator 520 for a corresponding conductor 505 portion can be formed of a plurality of insulating sections 610, and the number of different insulating sections 610 can vary. As FIG. 6 shows, with an increase in the number of length divisions of the insulators 520, the number of different insulation lengths further increases. In the example illustrated in FIG. 6, seven different insulating section 610 lengths (e.g. L1, L2, L3, L4, L5, L6, and L7) may be used to insulate the corresponding conductor 505 portions. However, it should be noted that the increase in the number of different insulation lengths does not necessarily scale with the number of divisions, for example since some lengths of insulating sections 610 may be shared between insulating sections 610. For example, in FIG. 6, three insulating sections 610 may have a length of L1, two insulating sections 610 may have a length of L2, two insulating sections 610 may have a length of L3, two insulating sections 610 may have a length of L4, one insulating section 610 may have a length of L5, one insulating section 610 may have a length of L6, and one insulating section 610 may have a length of L7.

By dividing each of the insulators 520 into two or more abutting insulating sections 610, a potential path to ground (e.g. a ground fault) can be introduced (e.g. inside the slots 535 to the lamination stack 530 from the high voltage conductor 505 to the lamination stack 530). For example, at the joint 615 between abutting ends of abutting insulating sections 610, there may be a gap in the insulation provided around the conductor 505 by the abutting insulating sections 610, which could provide a path for a ground fault if not adequately addressed. In the embodiment of FIG. 6, this issue can be resolved by an additional overlapping insulator 630 disposed over abutting ends of abutting insulating sections 610 (e.g. disposed over the joints 615 formed by the abutting ends) of the abutting insulating sections 610. The overlapping insulator 630 can be configured to effectively insulate these joints 615, for example providing sufficient insulation so that, in conjunction with the corresponding plurality of abutting insulating sections 610, the corresponding conductor 505 portion may be insulated as effectively in the example of FIG. 6 as it would be using the single unified length of insulation in the example of FIG. 5. In embodiments, the overlapping insulator 630 can be made from the same material as the insulator 520 (e.g. the insulating sections 610), for example rigid insulation such as ceramic. In the case of ceramic, the overlapping insulator 630 can be manufactured to near shape, fired to make rigid, and then finish-machined if necessary. The length of the overlapping insulator 630 can be selected to provide a sufficient spacing (e.g. a voltage spacing with a length at least great enough) to prevent grounding at the joints (e.g. for the phase to neutral voltage). For example, voltage spacing through air and over a surface can be referred to from insulation systems standards (e.g. UL). In embodiments, a single overlapping insulator 630 may simultaneously cover/insulate all joints 615 within a joint section (e.g. staggered joints 615 which may be in proximity to one another axially). In other embodiments, the overlapping insulator 630 could be formed of multiple elements which jointly insulate all joints 615 (e.g. within a joint section), for example with each joint 615 being insulated by one of the elements of the overlapping insulator 630.

Additionally, if the insulator section 610 abutting ends (e.g. joints 615) are aligned between adjacent turns of the conductor 505 (e.g. in adjacent conductor 505 portions within the same slot 535 in the lamination 530), as shown in the lower portion of FIG. 6, a potential turn-to-turn short 650 can be created. This can occur as the voltage in the conductor 505, created by operation of the motor 110, builds approximately linearly along the path of the conductor 505, resulting in a voltage difference between turns of the conductor 505 (e.g. a voltage difference between adjacent conductor 505 portions in the same slot 535). Because of the close proximity of the aligned joints 615 of adjacent insulators 520 in a slot 535 (in which there is a gap in the insulation around the conductor 505), a potential short 650 between turns of the conductor 505 can occur. In embodiments (not shown), similar turn-to-turn short situations may also occur in instances when there is a turn from two different motor phases in the same slot 535, with the voltage differential of the phase-to-phase voltage.

Embodiments may resolve this issue by introducing a stagger to the joints 615 of the insulator sections 610, as shown in the upper portion of FIG. 6 (and further discussed herein), with the stagger resulting in a larger spacing (e.g. axially) between live conductor 505 portions configured to prevent electrical communication therebetween. The spacing of the stagger (e.g. abutting stagger distance) can be set to be at least sufficient to carry the turn-to-turn voltage and prevent shorting therebetween, e.g. 200V in an example, in order to prevent such a short. Voltage spacing through air and over surface can be referred to from insulation systems standards (e.g. UL, IEC or DIN VDE). In embodiments, the abutting stagger distance may be similar to or the same as the end stagger distance between adjacent ends of adjacent insulators extending out of the lamination stack and/or the turn spacing distance (e.g. S as shown in FIG. 6). In embodiments, the abutting stagger distance for all joints can be the same (e.g. greater than the minimum needed to prevent a potential short between turns). In other embodiments, there could be variation in the abutting stagger distance (e.g. so long as they all are greater than the minimum needed to prevent a potential short between turns).

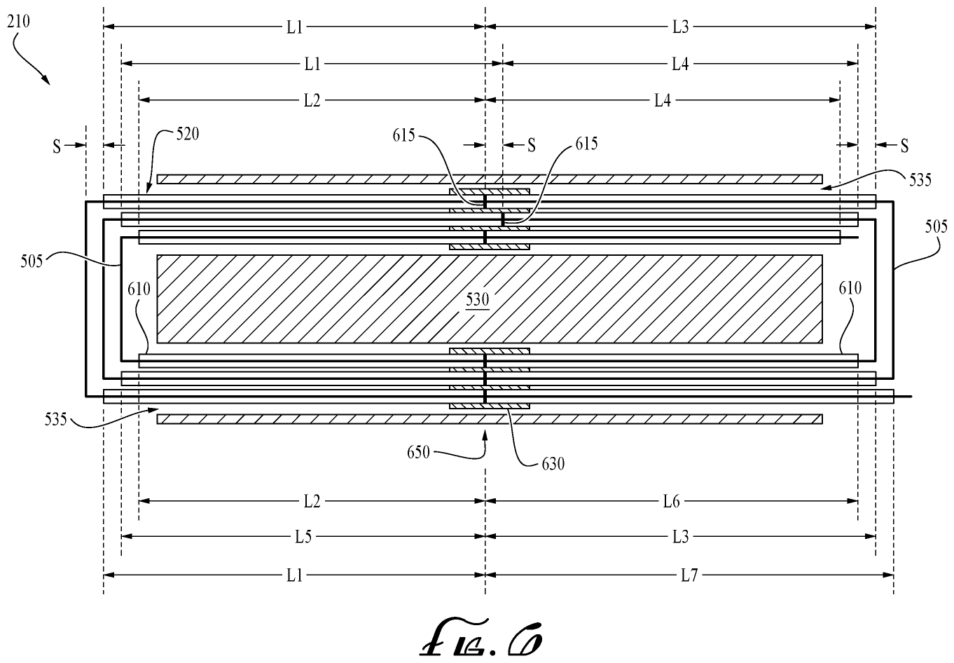

The length of the overlapping insulator 630 can be set (e.g. at a minimum) to allow a certain number of stagger steps and the required voltage (ground) overlap, per the exemplary schematic of FIG. 7. For instance, if there are n staggered positions (e.g. of the joints 615 between abutting ends of abutting insulating sections 610, with n being 2 in the example shown in FIG. 7) of distance S and a required voltage (e.g. ground) spacing of P, then the minimum length M of the overlapping insulator 630 would be n*S+2*P. In some embodiments, the overlapping insulator 630 length may be set a little longer than the minimum, for example to account for manufacturing tolerances. Any number of staggered positions is possible, for example only limited by available space and practicality. This staggering approach can allow a reduction in the number of different insulating section 610 lengths, for example by picking an appropriate number of joint staggers at each joint section to be covered by the overlapping insulator 630. This is shown in a simple form in FIG. 7, where for each turn staggered by distance S, the insulating section 610 can be kept at the same length L by using an appropriate number of stagger shifts, i.e. the first insulating section 610 is not staggered; the second insulating section 610 is staggered by distance S; the third insulating section 610 is staggered by distance 2xS (e.g. double the distance S).

These length variation numbers can become much greater (and the benefits of the disclosed approach can be even further highlighted) in a full motor 110. For example, an exemplary full motor 110 may in some embodiments consist of 96 turns. In such an exemplary motor 110 embodiment (e.g. an example without using divided insulating sections and/or such staggering), this may result in 96 different lengths of insulator 520 extending from the end of the lamination stack 530 at each end of the motor 110. In some embodiments, the motor 110 can be divided into multiple modules (see for example, FIG. 10), and therefore natural breaks may occur between modules where the insulator 520 can be effectively sub-divided (e.g. with the joints 615 of the abutting ends of the abutting insulating sections 610 disposed there). Typically, the overlapping insulator 630 for the joints 615 of such a joint section can be positioned at these breaks (e.g. between modules). By carefully choosing the locations of the staggers, the number of different lengths of insulating sections 610 can be reduced (e.g. with a plurality of insulating sections having the same length). For example, with respect to the exemplary 96 turn motor discussed above, the number of different lengths (e.g. length variants) of insulating sections 610 may be significantly reduced to a minimum of about 11 (e.g. since many of the insulating sections 610 may have the same length and can then be mixed and matched using the stagger approach to provide the appropriate length of insulation of each portion of the conductor 505 within a slot 535). In embodiments, this process can be automated by using an automated calculation process, which may trial multiple combinations (e.g. of stagger approaches and/or insulating section 610 lengths) until the minimum number of insulating sections 610 (or at least a reduced number of insulating sections 610) is selected.

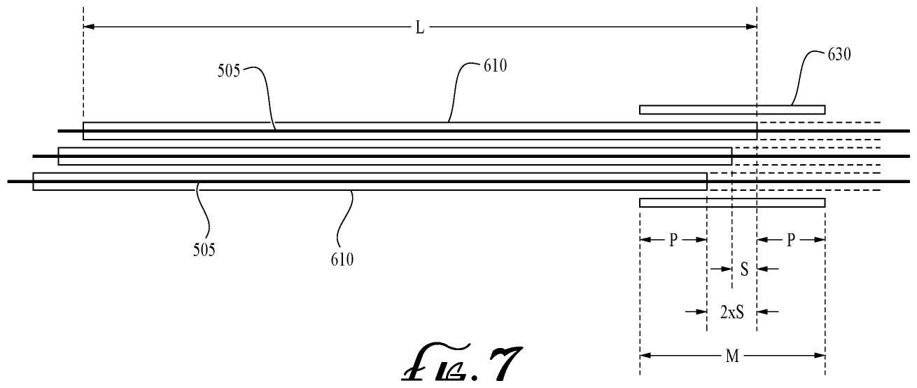

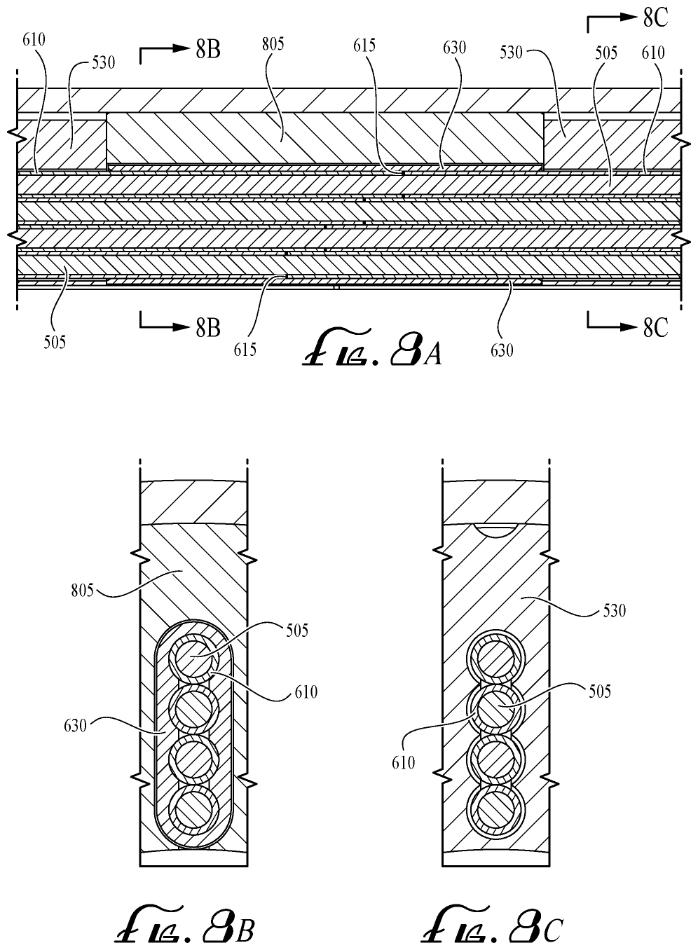

In some embodiments, the inclusion of the overlapping insulator 630 can create some difficulties with fitting of the parts (e.g. within the slots 535), due to the compact nature of a downhole motor 110. FIG. 8A illustrates one exemplary embodiment solution. The section shown in FIG. 8C illustrates a typical slot 535 cross section where the insulator 520 (formed by multiple abutting sections 610) and conductor 505 fit within a slot 535 in the lamination stack 530. Typically, the slot 535 is configured to be relatively close fitting, for example with a clearance sufficient to allow for the insulated conductor 505 portions while ensuring manufacturability. In a typical motor 110, this arrangement would extend the full length of the motor's stator 210. To fit the additional overlapping insulator 630 of disclosed embodiments such as those shown in FIG. 6, a larger slot space may be used, for example in a portion of the lamination where the joints 615 of the abutting insulating sections 610 (and thus the overlapping insulator 630) may be positioned. In one embodiment this can be achieved using a spacer 805, which may comprise steel, silicon steel, iron, nickel alloy, cobalt alloy, any compatible non-magnetic metal (e.g. bronze, stainless steel), polymer or inorganic material (e.g. ceramic), that fits between lamination stacks 530. This spacer 805 can be positioned (e.g. axially) in the same position as the overlapping insulator 630. In embodiments, the radial height of the spacer 805 may allow radial space for placement of the overlapping insulator 630 (e.g. forming a radial clearance/gap configured to hold the overlapping insulator 630). For example, FIG. 8B illustrates an exemplary section illustrating how the overlapping insulator 630 can fit (e.g. radially between the spacer 805 and the insulating sections 610). The slot/pocket in the spacer 805 can be close fitting to the outside geometry of the overlapping insulator 630 with a clearance sufficient to ensure manufacturability. Typically, the internal geometry of the overlapping insulator 630 will match the slot 535 in the lamination stack 530. The lamination stack 530 and spacer 805 can be located coaxially in the motor housing, with the slots rotationally aligned.

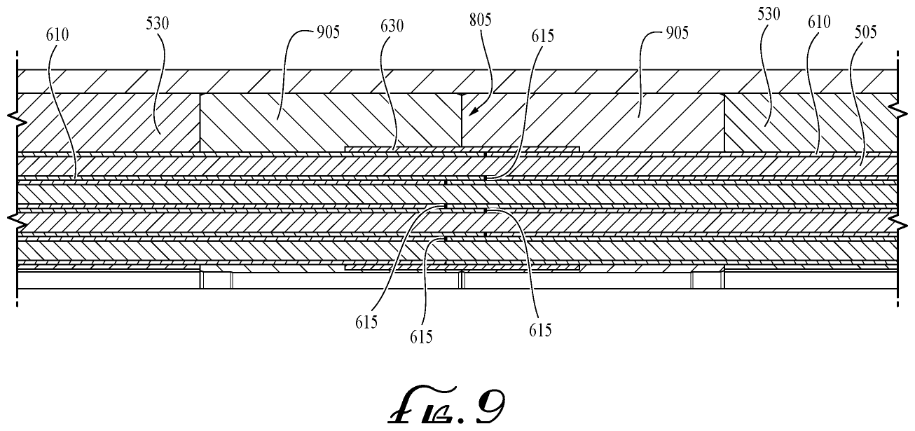

It also should be noted that the stager arrangement can vary, depending for example of the specific needs of the motor 110 at issue. For example, FIG. 8A demonstrates that the stagger arrangement of the joints 615 of the abutting insulating sections 610 can be stair-stepped. FIG. 9 illustrates a different exemplary stagger arrangement, in which the joints 615 are alternately/alternatingly staggered (e.g. back-and-forth, producing a zig-zag pattern). It should be understood that either of these stagger patterns and/or combinations thereof can be used at various joint sections, for example to provide effective insulation (e.g. preventing turn-to-turn short at the joints 615) while attempting to minimize the number of different insulating section 610 lengths. For example, in some embodiments, some of the joints 615 at a joint section can be stair-step staggered, while some joints 615 can be back-and-forth staggered. So long as the joint 615 staggering pattern at a joint section provides sufficient distance between adjacent joints 615 to prevent shorting issues, embodiments can use any such stagger pattern (for example when attempting to find ways to minimize the number of different insulating section 610 lengths (e.g. length variants) used for a motor stator 210).

FIG. 9 also illustrates that the overlapping insulator 630 does not need to be the full length of the spacer 805. In embodiments, the overlapping insulator 630 can be shorter than the spacer 805, for example by fitting into a pocket in the spacer 805. And in some embodiments, the spacer 805 can be divided in to two or more parts 905 (as shown in FIG. 9). In some embodiments, the pocket for the overlapping insulator can be formed jointly by pocket portions in two adjacent/abutting spacer parts 905, as shown for example in FIG. 9.

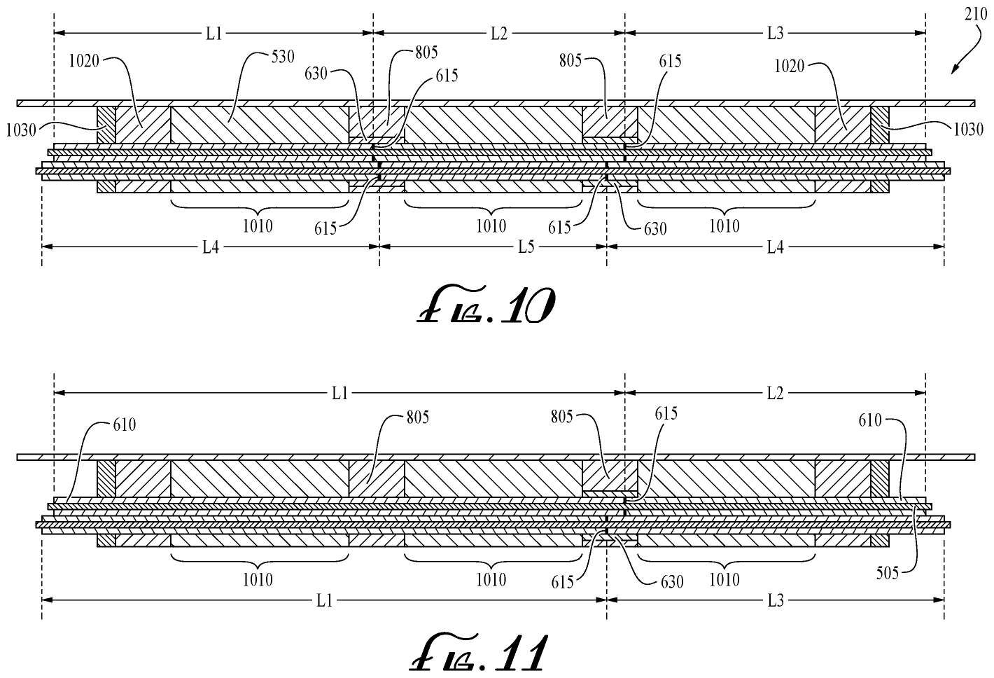

FIG. 10 illustrates schematically an overall exemplary stator 210 from a downhole motor 110. In this exemplary embodiment, the stator 210 comprises three repeated modules 1010 (e.g. lamination stacks 530 with insulated conductor 505 therein), however a higher number of modules 1010 is possible in other embodiments. In the exemplary embodiment with three repeated modules 1010, the stator 210 can comprise three lamination stacks 530, two spacers 805, one or more optional end spacer 1020 (which may be similar to a spacer 805), and one or more end insulator 1030 through which the winding/conductor passes. In the embodiment of FIG. 10, each spacer 805 can contain an overlapping insulator 630 (e.g. the joint 615 sections may align with the spacers 805). In the example of FIG. 10, five different insulating section 610 lengths can be used (e.g. L1, L2, L3, L4, and L5, with L4 being used for two separate insulating sections 610), for example with two of the insulating sections 610 having the same length. Thus, the number of different insulating section 610 lengths/length variants (e.g. five as shown here) can be less than the total number of insulating sections in the stator (e.g. six as shown here). This is also shown in FIG. 11, which uses three different lengths of insulating sections 610 for four total insulating sections 610, for example with two insulating sections 610 having the same length of L1, and each of the remaining insulating sections 610 having their own unique length (L2 or L3). So, in embodiments, a plurality of insulating sections 610 can have the same length, allowing for a reduction in the length variants for the insulating sections 610.

As shown in FIG. 11, if one or more sufficiently long insulating section 610 can be used, an overlapping insulator 630 may not be used at one or more spacer 805 location. Rather, as shown in FIG. 11, the insulating sections 610 can extend across multiple modules 1010, in this example 2 modules, before a joint 615 is made between abutting insulating sections 610 (e.g. with a corresponding overlapping insulator 630).

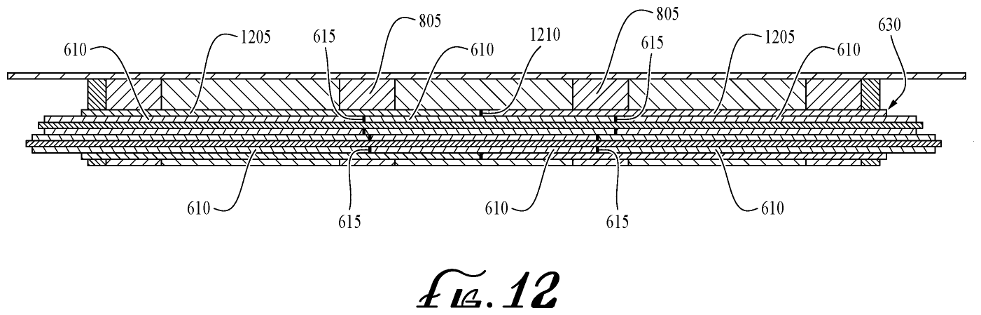

In some embodiments, the overlapping insulator 630 can be of a similar length as the insulating sections 610, and/or can also pass through the lamination stack 530 (e.g. extending beyond the spacer 805, for example with a plurality of abutting overlapping insulator portions 1205 jointly extending substantially the entire length of the stator 210 within the slots 535). An example of this setup is shown in FIG. 12. In embodiments, the divisions 1210 in the overlapping insulator 630 (e.g. the joints between the abutting overlapping insulator portions 1205) can be arbitrary, other than not aligning with (e.g. being spaced apart from) the joints 615 of abutting insulating sections 610. Typically, the divisions 1210 in the overlapping insulator 630 would be spaced apart from the joints 615 of the abutting insulating sections 610 by at least the voltage spacing to prevent grounding and effectively insulate those joints 615.

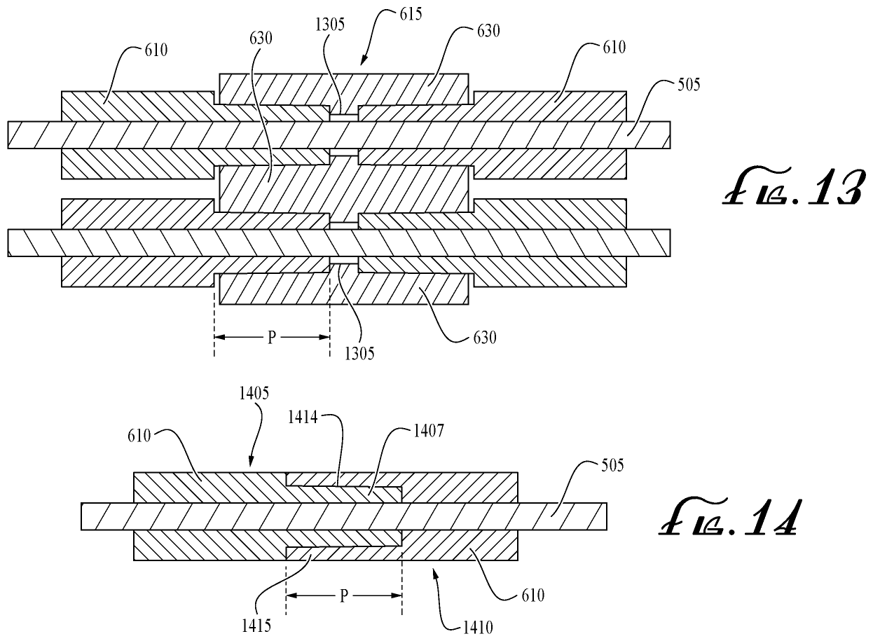

FIG. 13 schematically illustrates another exemplary approach for applying the overlapping insulator 630 at the joints 615 of the abutting insulating sections 610. For example, each abutting end of abutting insulating sections 610 can be stepped (e.g. radially inward), forming an inset. In the embodiment of FIG. 13, the abutting ends of the insulating sections 610 can be similarly or identically stepped. The overlapping insulator 630 can be formed/shaped to fit within a pocket jointly formed by the inset portions of the stepped abutting ends, and the overlapping insulator 630 can be disposed in the pocket. In some embodiments, the abutting ends may actually abut. In other embodiments, as shown in FIG. 13, there may be a small gap between the abutting ends of the abutting insulating sections 610, and a projection 1305 (e.g. radially extending) of the overlapping insulator 630 can fit in the gap between the abutting ends. In some embodiments, the projection 1305 may extend sufficiently to contact the conductor 505 portion therein, while in other embodiments the projection 1305 may be shorter, leaving an air space around the conductor 505 portion at the joint. In some embodiments, exterior overlapping insulator elements may have only a single projection (e.g. extending towards the corresponding adjacent conductor portion), while interior overlapping insulator elements may have two projections (e.g. extending towards both adjacent conductor portions). In embodiments, the stepped abutting ends can each have a step length (e.g. with the stepped portion extending axially at the abutting ends) of at least the voltage spacing (P), which may prevent grounding issues.

FIG. 14 illustrates schematically a different exemplary approach for addressing overlapping insulator issues (e.g. to prevent grounding) at the joints of the abutting insulating sections 610. For example, In FIG. 14, the abutting ends of abutting insulating sections 610 can be configured to correspondingly mate, with a male abutting end 1405 mating to a female abutting end 1410. For example, the corresponding male abutting end 1405 can comprise a stepped projection 1407 (e.g. extending axially), and the corresponding female abutting end 1410 can comprise a stepped receptacle 1414 (e.g. configured to receive the stepped projection). In embodiments, the length of the stepped projection 1407 can be approximately equal to a length of the stepped receptacle 1414, forming a secure mating fit. In embodiments, the length of the stepped projection 1407 and/or stepped receptacle 1414 can be at least the voltage spacing (P), for example to protect against grounding. In this approach, the overlapping insulator may be integral to the abutting insulating sections 610, for example formed by the stepped receptacle 1414 having a lip 1415 of insulating material that extends over/overlaps the stepped projection 1407. In this way, the live joint surface can be separated from the exterior (e.g. the lamination stack) by insulation, which may effectively protect against grounding. By using integral (e.g. built-in) overlapping insulation, no separate overlapping insulator piece/element may be needed, for example since the shape of the abutting ends can integrally provide the overlapping insulator protection against grounding, along with the joint. Additionally, in some embodiments, this arrangement may integrally provide stagger (e.g. protection against turn-to-turn shorting) for the joints as well. The specific shape of the stepped portions (e.g. the projection 1407 and receptacle 1414 with insulated lip 1415) can vary, so long as the design provides (e.g. integrally) the voltage spacing and insulation at the joint. In embodiments, each insulating section 610 can have one male end 1405 and one female end 1410, and orientation of the abutting insulating section ends can provide the proper insulation at the joints.

The examples shown in the figures are only illustrative, and are not limiting. In embodiments, any number of conductor turns can be possible, for example only limited by practicality of fitting the number of turns to the motor. In embodiments, any number of conductor portions can pass through a given stator slot. In embodiments, there can be any number of turns and phases.

In embodiments, the insulating sections do not need to be tubular. For example, the insulating sections can be of a rectangular cross section or any other compatible cross section effective for electrically insulating the conductor portions. And while the described embodiments specifically mention rigid insulations, non-rigid insulation material can also be used for the insulating sections. For example, the insulating sections can comprise wrapped sheet insulation construction (e.g. in instances where a sheet size is too small to make a full-length insulator, e.g. a flexible ceramic sheet). In embodiments, the overlapping insulator may be formed of a sheet insulating material, which may be wrapped around the insulating section joints, e.g. a flexible ceramic sheet. In embodiments, the overlapping insulator can be formed of the same insulating material as the insulating sections; in other embodiments, the overlapping insulator can be formed of different insulating materials than the insulating sections.

In embodiments, the slot geometry of the slots in the laminations can be square, rounded, oval, etc. In embodiments, the slot geometry does not strictly have to match the insulator and conductor geometry. This can also apply to the slot/pocket in which overlapping insulator fits and the internal slot geometry of the overlapping insulator.

In some embodiments, the spacer may be a single unified element. In some embodiments, two parts may be axially aligned to form the spacer, for example as shown in FIG. 9. In some embodiments, the spacer may not be a single part/element, but for example can be formed from a (e.g. radial) stack of laminations punched with the appropriate slot/pocket feature. In embodiments the end spacer (for example as discussed with respect to FIGS. 11-12) may contain an overlapping insulator, for example with the insulator split and staggered at this point.

While the figures were discussed specifically with respect to rigid and/or inorganic insulation materials such as ceramics, in embodiments the insulator, insulating sections, and/or overlapping insulator can be formed of any insulation materials, such as PEEK, Ceramic Filled PEEK, Kapton, Mica, Silicone Mica Composites, Alumina, Alumina/Zirconia composites, glass composites, Cordierite (e.g. Magnesium aluminum silicate), Aluminum Nitride, Silicon Nitride, and combinations thereof. In embodiments, the motor can be of any length and/or of any modular split. Furthermore, the teachings herein can be applicable to other winding types where an overlap in the insulation may be useful to achieve the overall length, for example in a long motor.

### ADDITIONAL DISCLOSURE

The following are non-limiting, specific embodiments in accordance with the present disclosure:

In a first embodiment, a stator (e.g. for an ESP motor for use at a high operating temperature downhole in a well) can comprise a lamination stack having a plurality of axial slots; an electrical conductor disposed in the plurality of slots and forming a coil with turns, with each turn spaced apart by a spacing distance (such a distance S); an electrical insulator for each portion of the conductor for each turn within one of the plurality of slots, wherein: the insulator is configured to electrically insulate the portion of the conductor, each insulator comprises two ends extending out of the one of the plurality of slots (e.g. the corresponding slot), adjacent ends of adjacent insulators are staggered by an end stagger distance (e.g. corresponding approximately to the turn spacing distance (e.g. a distance S)), each insulator comprises two or more abutting insulating sections, a joint is formed by abutting ends of abutting insulating sections, and the joints of adjacent insulators are staggered (e.g. not aligned) by an abutting stagger distance (e.g. corresponding approximately to the turn spacing distance); and one or more overlapping insulator disposed over the joints of adjacent insulators within each slot (and configured to insulate the joints, for example to prevent inadvertent grounding).

A second embodiment can include the stator of the first embodiment, wherein each insulating section comprises rigid insulation.

A third embodiment can include the stator of the first or second embodiments, wherein each insulating section comprise rigid, inorganic insulation, such as ceramic, PEEK, Ceramic Filled PEEK, Kapton, Mica, Silicone Mica Composites, Alumina, Alumina/Zirconia composites, glass composites, Cordierite (e.g. Magnesium aluminum silicate), Aluminum Nitride, Silicon Nitride, and combinations thereof.

A fourth embodiment can include the stator of any one of the first to third embodiments, wherein each insulating section is a rigid tube of electrical insulation material surrounding the conductor.

A fifth embodiment can include the stator of any one of the first to fourth embodiments, wherein the abutting stagger distance is approximately the same as the end stagger distance and/or the turn spacing distance.

A sixth embodiment can include the stator of any one of the first to fifth embodiments, wherein a length of the stator is greater than a length available for the rigid insulation configured for high temperature usage.

A seventh embodiment can include the stator of any one of the first to sixth embodiments, wherein each overlapping insulator is configured to simultaneously cover/insulate staggered joints of adjacent insulators (e.g. a single, continuous overlapping insulator for all staggered joints (e.g. within approximate stagger distance of each other) in slot).

An eighth embodiment can include the stator of any one of the first to seventh embodiments, wherein the ESP motor has a length of approximately 3 to 20 meters (or alternatively approximately 5-20 meters, 7-20 meters, 10-20 meters, 15-20 meters, 5-15 meters, 7-15 meters, 5-10 meters, or 7-10 meters).

A ninth embodiment can include the stator of any one of the first to eighth embodiments, wherein each insulating section has a length of approximately 0.5-3 meters (or alternatively approximately 1-3 meters, 1-2 meters, 1 meter, or no more than 1 meter (e.g. 0.5-1 meter)).

A tenth embodiment can include the stator of any one of the first to ninth embodiments, wherein the overlapping insulator has a length sufficient and/or is disposed with respect to the joints sufficiently to prevent grounding at the joints (e.g. providing at least sufficient distance for voltage spacing (P), e.g. the phase to neutral voltage).

An eleventh embodiment can include the stator of any one of the first to tenth embodiments, wherein the abutting stagger distance (and/or end stagger distance and/or turn spacing distance) is sufficient to carry turn-to-turn voltage (e.g. to prevent a short at the joints between adjacent insulators, for example based on the voltage between adjacent joints).

A twelfth embodiment can include the stator of any one of the first to eleventh embodiments, wherein the overlapping insulator has a length sufficient to address abutting stagger distance for joints of adjacent insulators in a slot, as well as additional length to prevent grounding at the joints.

A thirteenth embodiment can include the stator of any one of the first to twelfth embodiments, wherein (e.g. when there are only two adjacent insulators per slot or when the joints of the three or more adjacent insulators are alternately staggered—e.g. a back-and-forth, zig-zag stagger pattern as shown in FIG. 9) the length of the overlapping insulator is at least the abutting stagger distance plus twice the voltage spacing (P) to prevent grounding.

A fourteenth embodiment can include the stator of any one of the first to twelfth embodiments, wherein (e.g. when all joints are stair-step staggered, as shown in FIG. 8A) the length of the overlapping insulator is at least a sum of all abutting stagger distances of the (adjacent) staggered joints plus twice the voltage spacing (P) to prevent grounding.

A fifteenth embodiment can include the stator of any one of the first to fourteenth embodiments, wherein each insulating section has a length, and the lengths of some of the insulating sections correspond (e.g. are approximately equal).

A sixteenth embodiment can include the stator of any one of the first to fifteenth embodiments, wherein at least two of the insulating sections have approximately the same length.

A seventeenth embodiment can include the stator of any one of the first to sixteenth embodiments, wherein at least three of the insulating selections have approximately the same length.

An eighteenth embodiment can include the stator of any one of the first to seventeenth embodiments, wherein two or more of the insulating sections belong to group I, and two or more of the insulating sections belong to group II, wherein the insulating sections in group I are all approximately equal in length, and the insulating sections in group II are all approximately equal in length.

A nineteenth embodiment can include the stator of any one of the first to eighteenth embodiments, wherein two or more of the insulating sections belong to group I, and two or more of the insulating sections belong to group II, two or more of the insulating sections belong to group III, and two or more of the insulating sections belong to group IV, wherein the insulating sections in group I are all approximately equal in length, the insulating sections in group II are all approximately equal in length; the insulating sections in group III are all approximately equal in length, and the insulating sections in group IV are all approximately equal in length.

A twentieth embodiment can include the stator of any one of the first to nineteenth embodiments, wherein the insulating sections comprise a number of different lengths, and the number of different lengths is less than the number of insulating sections.

A twenty-first embodiment can include the stator of any one of the first to twentieth embodiments, wherein the insulating sections comprise a number of different lengths, and the number of different lengths is less than double a number of the joints.

A twenty-second embodiment can include the stator of any one of the first to twenty-first embodiments, wherein the ESP motor comprises a number of (stator) turns, and the insulating sections comprise a number of different lengths which is less than half, less than ⅓, less than ¼, less than ⅙, or less than ⅛ of the number of turns.

A twenty-third embodiment can include the stator of any one of the first to twenty-second embodiments, wherein the ESP motor comprises 96 turns, but the insulating sections comprise only 11 different lengths (e.g. by positioning the joints and/or sizing the staggers to minimize the number of different lengths needed to mix-and-match in order to provide for the 96 different insulator lengths).

A twenty-fourth embodiment can include the stator of any one of the first to twenty-third embodiments, wherein the overlapping insulator comprises the same rigid insulation as the insulating sections (although in other embodiments, the overlapping insulator can comprise different insulation from the insulating sections).

A twenty-fifth embodiment can include the stator of any one of the first to twenty-fourth embodiments, wherein the lamination stack comprises two or more lamination stack portions, the stator further comprising one or more spacer disposed between adjacent lamination stack portions, and the overlapping insulator (e.g. and the staggered joints it covers) is (e.g. axially) aligned with the spacer (e.g. with the overlapping insulator radially between the spacer and the insulating sections).

A twenty-sixth embodiment can include the stator of any one of the first to twenty-fifth embodiments, wherein each lamination portion forms a stator module.

A twenty-seventh embodiment can include the stator of any one of the twenty-fifth to twenty-sixth embodiments, wherein the spacer provides radial clearance (e.g. around the adjacent insulators) sufficient for the overlapping insulator.

A twenty-eighth embodiment can include the stator of any one of the twenty-fifth to twenty-seventh embodiments, wherein the spacer comprises a pocket configured so the overlapping insulator fits therein (e.g. providing sufficient radial clearance for the overlapping insulator and/or providing axial pocket ends sufficient to fit and hold the position of the overlapping insulator, securing the location of the overlapping insulator radially and axially).

A twenty-ninth embodiment can include the stator of any one of the twenty-fifth to twenty eighth embodiments, wherein each (or at least one) of the one or more spacer comprises two adjacent spacer parts, wherein each adjacent spacer part comprises a partial pocket, and the partial pockets of the adjacent spacer parts jointly form a pocket configured so the overlapping insulator fits therein.

A thirtieth embodiment can include the stator of any one of the twenty-fifth to twenty-ninth embodiments, wherein the one or more spacer comprises at least two spacers, wherein (e.g. based on the length of the insulating sections and therefore the positions of the joints) at least one of the spacers does not have a corresponding overlapping insulator (e.g. has a radial height greater than the spacer which does have a corresponding overlapping insulator).

A thirty-first embodiment can include the stator of any one of the twenty-fifth to thirtieth embodiments, wherein the overlapping insulator has a length greater than the spacer.

A thirty-second embodiment can include the stator of any one of the twenty-fifth to thirty-first embodiments, wherein the length of the overlapping insulator is similar to the length of the insulating sections and/or sufficient to span at least a lamination stack portion and a spacer (or alternatively at least a lamination stack portion and two spacers).

A thirty-third embodiment can include the stator of any one of the first to thirty-second embodiments, wherein the overlapping insulator comprises two or more abutting overlapping insulator sections, and the overlapping insulator extends substantially the entire length of the lamination stack (e.g. with ends extending out of the lamination stack).

A thirty-fourth embodiment can include the stator of the thirty-third embodiment, wherein divisions between the two or more abutting overlapping insulator sections are spaced from the joints (e.g. at least voltage spacing (P)).

A thirty-fifth embodiment can include the stator of any one of the thirty-third to thirty-fourth embodiments, wherein divisions between the two or more abutting overlapping insulator sections are disposed within the lamination stack portions (e.g. not located at/aligned with the spacers).

A thirty-sixth embodiment can include the stator of any one of the first to thirty-fifth embodiments, wherein each abutting end of abutting insulating sections is stepped, and the overlapping insulator is disposed within a pocket jointly formed by the stepped abutting ends.

A thirty-seventh embodiment can include the stator of the thirty-sixth embodiment, wherein the stepped abutting ends each have a step length (e.g. axially) of at least the voltage spacing (P).

A thirty-eighth embodiment can include the stator of any one of the first to thirty-fifth embodiments, wherein the abutting ends of abutting insulating sections are configured to correspondingly mate, with a male abutting end mating to a female abutting end, the corresponding male abutting end comprises a stepped projection, the corresponding female abutting end comprises a stepped receptacle, a length of the stepped projection is approximately equal to a length of the stepped receptacle, and the length of the stepped projection and/or stepped receptacle is at least the voltage spacing (P).

A thirty-ninth embodiment can include the stator of the thirty-eighth embodiment, wherein the overlapping insulator is integral to the abutting insulating sections (e.g. no separate overlapping insulator piece is needed, since the shape of the abutting ends integrally provides the overlapping insulator protection against grounding, along with the joint).

In a fortieth embodiment, a method of assembling a stator for an ESP motor (e.g. the stator of any one of the first to thirty-ninth embodiments) comprises providing a lamination stack having a plurality of axially extending slots; disposing an electrical conductor in the plurality of slots to form a coil with turns, wherein each turn is spaced apart; disposing an electrical insulator in order to insulate each portion of the conductor for each turn within one of the plurality of slots, wherein: each insulator comprises two ends extending out of one of the plurality of slots, adjacent ends of adjacent insulators are staggered by an end stagger distance, each insulator comprises two or more abutting insulating sections, a joint is formed by abutting ends of abutting insulating sections, and the joints of adjacent insulators are staggered (e.g. not aligned) by an abutting stagger distance; and disposing one or more overlapping insulator over the joints of adjacent insulators within each slot (e.g. to insulate the joints and prevent grounding).

A forty-first embodiment can include the method of the fortieth embodiment, wherein the insulating sections each comprise rigid insulation (e.g. rigid insulation tubing).

A forty-second embodiment can include the method of the fortieth or forty-first embodiments, wherein disposing an electrical insulator comprises disposing two or more abutting insulating sections.

A forty-third embodiment can include the method of the forty-second embodiment, wherein disposing two or more abutting insulating sections comprises disposing a number of insulating sections axially abutting to jointly provide a length of the electrical insulator.

A forty-fourth embodiment can include the method of any one of the fortieth to forty-third embodiments, wherein the abutting stagger distance corresponds to the end stagger distance.

A forty-fifth embodiment can include the method of any one of the fortieth to forty-fourth embodiments, further comprising selecting the abutting stagger distance to be sufficient to carry turn-to-turn voltage (e.g. to prevent a short at the joints between adjacent insulators).

A forty-sixth embodiment can include the method of any one of the fortieth to forty-fifth embodiments, further comprising selecting a length of the overlap insulator sufficient to address abutting stagger distance for joints of adjacent insulators in a slot, as well as preventing grounding at the joints.

A forty-seventh embodiment can include the method of any one of the fortieth to forty-sixth embodiments, further comprising selecting a length of each insulating section (e.g. to minimize the number of different length variants of insulating sections in some embodiments).

A forty-eighth embodiment can include the method of any one of the fortieth to forty-seventh embodiments, wherein the length of some of the insulating sections correspond (e.g. are approximately equal).

A forty-ninth embodiment can include the method of any one of the forty-seventh to forty-eighth embodiments, wherein selecting a length of each insulating section comprises selecting at least two of the insulating sections to have approximately the same length.

A fiftieth embodiment can include the method of any one of the forty-seventh to forty-ninth embodiments, wherein selecting a length of each insulating section comprises selecting at least three of the insulating selections to have approximately the same length.

A fifty-first embodiment can include the method of any one of the forty-seventh to fiftieth embodiments, wherein selecting a length of each insulating section comprises selecting two or more of the insulating sections to belong to group I, and two or more of the insulating sections to belong to group II, wherein the insulating sections in group I are all approximately equal in length, and the insulating sections in group II are all approximately equal in length.

A fifty-second embodiment can include the method of any one of the forty-seventh to fifty-first embodiments, wherein selecting a length of each insulating section comprises selecting two or more of the insulating sections to belong to group I, two or more of the insulating sections to belong to group II, two or more of the insulating sections to belong to group III, and two or more of the insulating sections to belong to group IV, wherein the insulating sections in group I are all approximately equal in length, the insulating sections in group II are all approximately equal in length; the insulating sections in group III are all approximately equal in length, and the insulating sections in group IV are all approximately equal in length.

A fifty-third embodiment can include the method of any one of the forty-seventh to fifty-second embodiments, wherein selecting a length of each insulating section comprises selecting the insulating sections to comprise a number of different lengths which is less than the number of insulating sections (e.g. used in the stator).

A fifty-fourth embodiment can include the method of any one of the forty-seventh to fifty-third embodiments, wherein selecting a length of each insulating section comprises selecting the insulating sections to comprise a number of different lengths which is less than double a number of the joints.

A fifty-fifth embodiment can include the method of any one of the forty-second to fifty-fourth embodiments, wherein disposing two or more abutting insulating sections comprises mixing and matching insulating sections of different lengths (e.g. from the selection).

A fifty-sixth embodiment can include the method of any one of the fortieth to fifty-fifth embodiments, further comprising selecting locations of joints and the abutting stagger distances to minimize the number of different length variants of insulating sections (e.g, wherein the stagger distances can vary beyond the minimum needed to carry turn-to-turn voltage).

A fifty-seventh embodiment can include the method of the fifty-sixth embodiment, further comprising limiting inventory of different length variants (e.g. accordingly).

A fifty-eighth embodiment can include the method of any one of the fifty-sixth to fifty-seventh embodiments, further comprising limiting manufacture of different length variants (e.g. accordingly).

A fifty-ninth embodiment can include the method of any one of the fortieth to fifty-eighth embodiments, wherein the lamination stack comprises two or more lamination stack portions, the method further comprising disposing a spacer (e.g. axially) between adjacent lamination stack portions.

A sixtieth embodiment can include the method of the fifty-ninth embodiment, wherein disposing one or more overlapping insulator comprises disposing one of the one or more overlapping insulator aligned (axially) with the spacer.

A sixty-first embodiment can include the method of any one of the fifty-ninth to sixtieth embodiments, wherein the spacer has a radial height allowing radial placement of the overlapping insulator therewith within a housing.

A sixty-second embodiment can include the method of any one of the fifty-ninth to sixty-first embodiments, wherein the spacer has a pocket configured for placement of the overlapping insulator therein.

A sixty-third embodiment can include the method of any one of the fortieth to sixty-second embodiments, wherein the motor has a length of approximately 3-20 meters (or alternatively, approximately 5-20, 7-20, 10-20, 15-20, 5-15, 7-15, 5-10, 7-10 meters), and the insulating sections have a length ranging from approximately 0.5 to 3.0 meters (or alternatively, approximately 1-3, 1-2, or 0.5-3 meters).

A sixty-fourth embodiment can include the method of any one of the fortieth to sixty-third embodiments, further comprising using an automated calculation process to determine a minimum number of different length variants of insulating sections (e.g. using an iterative and/or trial and-error process).

A sixty-fifth embodiment can include the method of any one of the fortieth to sixty-fourth embodiments, further comprising selecting the minimum number of different length variants of insulating sections (e.g. to assemble the ESP motor).

A sixty-sixth embodiment can include the method of any one of the sixty-fourth to sixty-fifth embodiments, further comprising reducing or minimizing the number of different length variants of insulating sections in inventory and/or maintaining inventory having only the minimum number of different length variants of insulating sections.

A sixty-seventh embodiment can include the method of any one of the sixty-fourth to sixty-sixth embodiments, further comprising reducing or minimizing the number of different length variants of insulating sections manufactured (or purchased) and/or manufacturing (or having manufactured or purchasing) only the minimum number of different length variants of insulating sections.

In a sixty-eighth embodiment, an ESP assembly comprising an electric motor coupled to a pump, and the stator of any one of the first to thirty-ninth embodiments being in the motor.

In a sixty-ninth embodiment, placement of the ESP assembly of the sixty-eighth embodiment in a wellbore and operation of same to pump formation fluids from the wellbore to the surface.

A seventieth embodiment can include the placement method of the sixty-ninth embodiment, wherein the electric motor of the ESP assembly operates at high temperature (e.g. above approximately 250 degrees Celsius).

A seventy-first embodiment can include the placement method of the sixty-ninth or seventieth embodiments, wherein the electric motor of the ESP assembly operates in a high temperature (e.g. above approximately 250 degrees Celsius) wellbore environment.

While embodiments have been shown and described, modifications thereof can be made by one skilled in the art without departing from the spirit and teachings of this disclosure. The embodiments described herein are exemplary only, and are not intended to be limiting. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Use of broader terms such as comprises, includes, having, etc. should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded. The use of the terms such as “high-pressure” and “low-pressure” is intended to only be descriptive of the component and their position within the systems disclosed herein. That is, the use of such terms should not be understood to imply that there is a specific operating pressure or pressure rating for such components. For example, the term “high-pressure” describing a manifold should be understood to refer to a manifold that receives pressurized fluid that has been discharged from a pump irrespective of the actual pressure of the fluid as it leaves the pump or enters the manifold. Similarly, the term “low-pressure” describing a manifold should be understood to refer to a manifold that receives fluid and supplies that fluid to the suction side of the pump irrespective of the actual pressure of the fluid within the low-pressure manifold.

Accordingly, the scope of protection is not limited by the description set out above but is only limited by the claims which follow, that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

What is claimed is:

1. A stator for an ESP motor for use at a high operating temperature downhole in a well, comprising:
a lamination stack having a plurality of axial slots;
an electrical conductor disposed in the plurality of slots and forming a coil with turns, with each turn spaced apart by a spacing distance;
an electrical insulator for each portion of the conductor for each turn within one of the plurality of slots, wherein:
the insulator is configured to electrically insulate the portion of the conductor,
each insulator comprises two ends extending out of the corresponding slot,
adjacent ends of adjacent insulators are staggered by an end stagger distance,
each insulator comprises two or more abutting insulating sections,
a joint is formed by abutting ends of abutting insulating sections,
the joints of adjacent insulators are staggered by an abutting stagger distance, and
each insulating section comprises rigid insulation configured for high operating temperature; and
one or more overlapping insulator disposed over the joints of adjacent insulators within each slot.

2. The stator of claim 1, wherein each insulating section comprise a rigid, inorganic insulation selected from the following: ceramic material, PEEK, Ceramic Filled PEEK, Kapton, Mica, Silicone Mica Composites, Alumina, Alumina/Zirconia composites, glass composites, Cordierite (Magnesium aluminum silicate), Aluminum Nitride, Silicon Nitride, and combinations thereof.

3. The stator of claim 1, wherein the ESP motor has a length of approximately 3 to 20 meters, and wherein each insulating section has a length of approximately 0.5-3 meters.

4. The stator of claim 1, wherein the abutting stagger distance is sufficient to carry turn-to-turn voltage, and wherein the overlapping insulator has a length sufficient to address abutting stagger distance for joints of adjacent insulators in a slot, as well as additional length to prevent grounding at the joints.

5. The stator of claim 1, wherein each insulating section has a length, and the lengths of some of the insulating sections correspond.

6. The stator of claim 1, wherein two or more of the insulating sections belong to group I, and two or more of the insulating sections belong to group II, wherein the insulating sections in group I are all approximately equal in length, and the insulating sections in group II are all approximately equal in length.

7. The stator of claim 1, wherein the insulating sections comprise a number of different lengths, and the number of different lengths is less than a number of insulating sections in the stator.

8. The stator of claim 1, wherein the lamination stack comprises two or more lamination stack portions, the stator further comprising one or more spacer disposed between adjacent lamination stack portions, and the overlapping insulator is axially aligned with the spacer.

9. The stator of claim 1, wherein each abutting end of abutting insulating sections is stepped, the overlapping insulator is disposed within a pocket jointly formed by the stepped abutting ends, and the stepped abutting ends each have a step length of at least the voltage spacing.

10. The stator of claim 1, wherein the abutting ends of abutting insulating sections are configured to correspondingly mate, with a male abutting end mating to a female abutting end, the corresponding male abutting end comprises a stepped projection, the corresponding female abutting end comprises a stepped receptacle, a length of the stepped projection is approximately equal to a length of the stepped receptacle, the length of the stepped projection and stepped receptacle is at least the voltage spacing, and the overlapping insulator is integral to the abutting insulating sections.

11. A method of assembling a stator for an ESP motor, comprising:
providing a lamination stack having a plurality of axially extending slots;
disposing an electrical conductor in the plurality of slots to form a coil with turns, wherein each turn is spaced apart;
disposing an electrical insulator in order to insulate each portion of the conductor for each turn within one of the plurality of slots, wherein:
each insulator comprises two ends extending out of one of the plurality of slots, adjacent ends of adjacent insulators are staggered by an end stagger distance,
each insulator comprises two or more abutting insulating sections,
a joint is formed by abutting ends of abutting insulating sections,
the joints of adjacent insulators are staggered by an abutting stagger distance, and
the insulating sections each comprise rigid insulation; and
disposing one or more overlapping insulator over the joints of adjacent insulators within each slot.

12. The method of claim 11, wherein disposing an electrical insulator comprises disposing two or more abutting insulating sections.

13. The method of claim 11, further comprising selecting the abutting stagger distance to be sufficient to carry turn-to-turn voltage, and selecting a length of the overlap insulator sufficient to address abutting stagger distance for joints of adjacent insulators in a slot, as well additional length to prevent grounding at the joints.

14. The method of claim 11, further comprising selecting a length of each insulating section, wherein the length of some of the insulating sections correspond.

15. The method of claim 14, wherein selecting a length of each insulating section comprises selecting two or more of the insulating sections to belong to group I, and two or more of the insulating sections to belong to group II, wherein the insulating sections in group I are all approximately equal in length, and the insulating sections in group II are all approximately equal in length.

16. The method of claim 14, wherein selecting a length of each insulating section comprises selecting the insulating sections to comprise a number of different lengths which is less than a number of insulating sections.

17. The method of claim 12, wherein disposing two or more abutting insulating sections comprises mixing and matching insulating sections of different lengths.

18. The method of claim 11, further comprising selecting locations of joints and the abutting stagger distances to minimize the number of different length variants of insulating sections.

19. The method of claim 11, wherein the lamination stack comprises two or more lamination stack portions, the method further comprising disposing a spacer between adjacent lamination stack portions, wherein disposing one or more overlapping insulator comprises disposing one of the one or more overlapping insulator aligned with the spacer.

20. The method of claim 12, wherein the motor has a length of approximately 3-20 meters and the insulating sections have a length ranging from approximately 0.5 to 3.0 meters, wherein disposing two or more abutting insulating sections comprises disposing a number of insulating sections axially abutting to jointly provide a length of the electrical insulator.
